(19) United States
(12) Patent Application Publication
(10) Pub. No.: US 2011/0126709 A1
(43) Pub. Date: Jun. 2, 2011

(54) USE OF CALCIUM EXCHANGED X-TYPE ZEOLITE FOR IMPROVEMENT OF REFINERY OFF-GAS PRESSURE SWING ADSORPTION

(75) Inventors: Bradley P. Russell, Wheaton, IL (US); Kirit M. Patel, Winfield, IL (US)

(73) Assignee: UOP LLC, Des Plaines, IL (US)

(21) Appl. No.: 12/629,307

(22) Filed: Dec. 2, 2009

(51) Int. Cl. B01D 53/047

(52) U.S. Cl. 95/143

(57) ABSTRACT

The invention uses a calcium exchanged zeolite molecular sieve adsorbent in a pressure swing adsorption process to purify hydrogen from refinery off-gas streams. The use of this adsorbent provides for an improvement in removal of methane and allows for faster cycle times and the processing of a higher volume of hydrogen for a given size adsorption bed.

### BACKGROUND OF THE INVENTION

The present invention relates to a pressure swing adsorption process for recovery of purified hydrogen from refinery off-gas. More particular, this invention relates to the use of a calcium exchanged X zeolite to provide improved recovery of purified hydrogen or to reduce the size of adsorbers.

Various types of catalytic hydrocarbon conversion reaction systems have found widespread utilization throughout the petroleum and petrochemical industries for effecting the conversion of hydrocarbons to different products. The reactions employed in such systems are either exothermic or endothermic. Of more importance to the present invention, the reactions often result in either the net production of hydrogen or the net consumption of hydrogen. Such reaction systems, as applied to petroleum refining, have been employed to effect numerous hydrocarbon conversion reactions including those which predominate in including catalytic reforming, ethylbenzene dehydrogenation to styrene, and propane and butane dehydrogenation.

Petroleum refineries and petrochemical complexes customarily comprise numerous reaction systems. Some systems within the refinery or petrochemical complex may result in the net production of hydrogen. Because hydrogen is relatively expensive, it has become the practice within the art of hydrocarbon conversion to supply hydrogen from reaction systems which result in the net production of hydrogen to reaction systems which are net consumers of hydrogen. Sometimes, the net hydrogen being passed to the net hydrogen-consuming reactions systems must be of high purity due to the reaction conditions and/or the catalyst employed in the systems. Such a situation requires treatment of the hydrogen from the net hydrogen-producing reaction systems to remove light hydrocarbons, carbon monoxide, and other impurities from the net hydrogen stream.

Alternatively, the hydrogen balance for the petroleum refinery or petrochemical complex may result in excess hydrogen, i.e., the net hydrogen-producing reaction systems produce more hydrogen than is necessary for the net hydrogen-consuming reaction systems. In such an event, the excess hydrogen may be sent to a petroleum refinery or petrochemical complex fuel system. However, because the excess hydrogen often has admixed therewith valuable components, such as hydrocarbons, it is frequently desirable to treat the excess hydrogen to recover these components prior to its passage to fuel.

Typical of the net hydrogen-producing hydrocarbon reaction systems are catalytic reforming, catalytic dehydrogenation of alkylaromatics and catalytic dehydrogenation of paraffins. Commonly employed net hydrogen-consuming reaction systems are hydrotreating, hydrocracking and catalytic hydrogenation. Among the above-mentioned net hydrogen-producing and consuming hydrocarbon reaction systems, catalytic reforming ranks as one of the most widely employed. By virtue of its wide application and its utilization as a primary source of hydrogen for the net hydrogen-consuming reactions systems, catalytic reforming has become well known in the art of hydrocarbon conversion reaction systems.

It is well known that high quality petroleum products in the gasoline boiling range including, for example, aromatic hydrocarbons such as benzene, toluene and the xylenes, are produced by a catalytic reforming process in which a naphtha fraction is passed to a reaction zone where it is contacted with a catalyst in the presence of hydrogen. Generally, the catalytic reforming reaction zone effluent, comprising gasoline boiling range hydrocarbons and hydrogen, is passed to a vapor-liquid equilibrium separation zone and is separated into a hydrogen-containing vapor phase and a hydrocarbon liquid phase. A portion of the hydrogen-containing vapor phase may be recycled to the reaction zone. A remaining hydrogen-containing vapor phase is available for use either by the net hydrogen-consuming processes or as fuel for the petroleum refinery or by the petrochemical complex fuel system. While a considerable portion of the hydrogen-containing vapor phase is required for recycle purposes, a substantial net excess is available for the other uses.

Substantial amounts of hydrogen are generated within the catalytic reforming reaction zone because the dehydrogenation of naphthenic hydrocarbons is one of the predominant reactions of the reforming process. Accordingly, a net excess of hydrogen is available for use as fuel or for use in a net hydrogen-consuming process such as the hydrotreating of sulfur-containing petroleum feedstocks. However, catalytic reforming also involves a hydrocracking function among the relatively low molecular weight hydrocarbons products including methane, ethane, propane, butanes and the pentanes, substantial amounts of which appear in the hydrogen-containing vapor phase separated from the reforming reaction zone effluent. These normally gaseous hydrocarbons have the effect of lowering the hydrogen purity of the hydrogen-containing vapor phase to the extent that purification is often required before the hydrogen is suitable for other uses. Moreover, if the net excess hydrogen is intended for use as fuel in the refinery or petrochemical complex fuel system, it is frequently desirable to maximize the recovery of hydrocarbons which are valuable as feedstock for other processes.

A pressure swing adsorption (PSA) process provides an efficient and economical means for separating a multi-component gas feed stream containing at least two gases having different adsorption characteristics. A more strongly adsorbable gas can be an impurity which is removed from a less strongly adsorbable gas which is taken off as product; or, the more strongly adsorbable gas can be the desired product, which is separated from the less strongly adsorbable gas. For example, it may be desired to remove carbon monoxide and light hydrocarbons from a hydrogen-containing feed stream to produce a purified, i.e., 99+%, hydrogen stream suitable for hydrocracking or other catalytic process where these impurities could adversely affect the catalyst or the reaction. On the other hand, it may be desired to recover more strongly adsorbable gases, such as ethylene, from a feed stream to produce an ethylene-rich product.

In pressure swing adsorption, a multi-component gas is typically fed to at least one of a plurality of adsorbent beds at an elevated pressure effective to adsorb at least one component, i.e. the adsorbate fraction, while at least one other component passes through, i.e. the non-adsorbed fraction. At a defined time, the feed stream to the adsorbent bed is terminated and the adsorbent bed is depressurized by one or more depressurization steps in which pressure is reduced to a defined level to permit the separated, less strongly adsorbed component or components remaining in the adsorption zone to be drawn off without significant concentration of the more strongly adsorbed components. The released gas typically is employed for pressure equalization and for subsequent purge steps. The bed is thereafter depressurized and often purged to desorb the more selectively adsorbed component of the feed stream from the adsorbent and to remove such gas from the feed end of the bed prior to the repressurization thereof to the adsorption pressure.

As noted above, PSA units are frequently used in the processing of refinery off-gas. It is desirable to reduce the cost of these units due to the high overall costs of refineries. One way to reduce cost is to reduce the PSA cycle time. By operating the PSA unit at a faster rate with faster cycles, the adsorbent volume and associated vessel size to process a given feed gas is decreased. However, when the PSA cycle time is reduced, there is generally a loss in PSA performance with lowered hydrogen recovery or an increase in impurities in the purified hydrogen stream. An activated carbon adsorbent is frequently used as the main adsorbent to remove light hydrocarbon impurities (e.g., methane) from hydrogen streams. The primary reason for a loss in hydrogen recovery is the mass-transfer resistance of the activated carbon adsorbent to methane (the controlling impurity) near the product end of the bed. This mass-transfer resistance can be reduced by using a smaller activated carbon particle size. However, due to the higher gas velocity in the bed with faster cycles, the smaller adsorbent particles will fluidize. Consequently, an improved adsorbent is desired that can be used in the top (product end) of refinery off-gas PSA beds to reduce mass-transfer resistance and simultaneously increase fluidization velocity, while maintaining favorable methane equilibrium capacity. Such an adsorbent would allow the overall bed volume to be reduced by using faster cycles without incurring a loss in hydrogen recovery and without bed lifting.

### SUMMARY OF THE INVENTION

It has been found that a calcium-exchanged X zeolite molecular sieve adsorbent performed significantly better than the current commercial activated carbon adsorbent. For example, at the target cycle time of 4.5 minutes, loading the top 25% of the bed with calcium-exchanged X zeolite molecular sieve 8×12 beads provided an increase of 1.4 percentage points in hydrogen recovery and a decrease of 5% in bed size factor compared to the activated carbon adsorbent. The lifting velocity of calcium-exchanged X zeolite (8×12 beads) was also about 15% greater than the activated carbon adsorbent. Therefore, loading the top section of the bed with a CaX molecular sieve provides the opportunity to reduce the cycle time (from about 6 minutes to about 4 minutes) and thereby reduce the overall system cost without a loss in hydrogen recovery. The cycle time is from 20 to 40% faster than previous systems that used activated carbon adsorbents.

This surprising result is apparently due to a faster mass-transfer for methane adsorption of the calcium X zeolite adsorbent compared to an equivalently sized activated carbon adsorbent. The faster mass-transfer performance can be ascertained from sharper internal bed concentration profiles and by sharper methane breakthrough curves during co-current depressurization steps in the PSA cycle. Also, the shape of the cycle time performance curves indicates faster mass-transfer for the calcium X zeolite compared to activated carbon since the performance advantage increases with decreasing cycle time.

Finally, comparing the methane equilibrium isotherms for the calcium X zeolite adsorbent and the activated carbon adsorbent shows that the calcium X zeolite adsorbent actually has a slightly worse equilibrium capacity for methane compared to the activated carbon adsorbent. However, the performance of the calcium X zeolite adsorbent in the PSA cycle is better than the activated carbon adsorbent, indicating faster mass-transfer with the calcium X zeolite adsorbent. One reason that the calcium X zeolite adsorbent performs better than other zeolite molecular sieve adsorbents is the high methane equilibrium capacity. The performance of a calcium X zeolite adsorbent may be modified by changing the silica-to-alumina ratio and/or the calcium exchange level. Decreases in the silica-to-alumina ratio and increases in the calcium exchange level will likely improve the performance of the adsorbent. These changes will improve the methane equilibrium capacity while maintaining the desirable fast mass-transfer rate. The calcium X zeolite adsorbent that was tested had a 2.3 silica-to-alumina ratio. A 2.0 silica-to-alumina ratio would improve the methane equilibrium capacity and would likely improve the overall performance further.

The top portion of the PSA bed (for example, 10% to 40%) can be loaded with the calcium X zeolite adsorbent in order to improve performance in refinery off gas applications. This allows the PSA cycle time to be reduced, and thereby reduce overall capital cost, without incurring a loss in hydrogen recovery. This can be used in new PSA units or in revamps. The calcium X zeolite adsorbent also provides better performance than activated carbon or other molecular sieves for trace removal of carbon monoxide and nitrogen, which can be beneficial in some refinery off gas applications.

### DETAILED DESCRIPTION OF THE INVENTION

A process is provided for removing methane from a gas stream comprising hydrogen, methane and other impurities, including carbon monoxide, nitrogen and ethane. The gas stream is passed through an adsorbent bed comprising a calcium X zeolite. These adsorbent beds provide for at least 20% more throughput (feed gas volume) as compared to an activated carbon adsorbent. Typically, from about 83 to 93% of feed hydrogen is recovered in the treated product gas stream. The calcium X zeolite comprises calcium exchanged at a level of from about 60 to 90%. The calcium X zeolite typically has a particle size from about 1.5 mm to 2.5 mm and has a silicon to aluminum ratio from about 1.0 to 1.3. The feed gas stream typically contains from about 60 to 90 95 mol % hydrogen.

A low-purity refinery off-gas feed (66% hydrogen) was used for pilot plant testing of PSA performance at reduced cycle times. The impact of cycle time on baseline (i.e., no molecular sieve) performance was measured down to 3 minutes over a range of product purities. Hydrogen recovery decreased by about 2 percentage points with a 3-minute cycle (compared to 6 minutes), and the performance loss was relatively insensitive to product purity. A 2-mm pelletized coconut carbon in the top 30% of the bed was tested and showed a performance gain of 0.5 percentage points in hydrogen recovery relative to the previously used coal-based activated carbon over the range of cycle times from 3 to 6 minutes. Finally, a calcium X zeolite adsorbent was tested (8×12 beads in the top 25% of the adsorbent bed). The calcium X zeolite adsorbent showed a significant performance advantage relative to both activated carbon adsorbents.

Testing was conducted in a pilot plant with the conditions given in Table 1. All tests were made using a bed of 1.5-inches (3.8 cm) diameter and 59.0-inches (1.5 m) packed height. Feed gas was prepared by mixing the main tube trailer gas containing methane, ethane, and propane with a liquid C4+ stream. The final feed gas to the bed was nearly saturated (37° C. dew-point), and the average composition over the course of testing is given in Table 2. A feed-repressurization cycle was used, and each of the step times in Table 1 was scaled by the overall cycle time for the fast-cycle tests. Runs were terminated based on achieving a steady methane concentration in the product. Run lengths were generally about two days. For a product purity specification of 1,000 ppmv methane, we were usually able to line out within ±200 ppmv or better of the specification.

TABLE 1
Pilot Plant Test Conditions.

| Cycle | Step | Begin Pressure, | End Pressure, |
|---|---|---|---|
| Step | Time, sec | kPa | kPa |
| Adsorb | 110 | 1530 | 2240 |
| Equalization | 55 | 2240 | 676 |
| Provide Purge | 20 | 676 | 400 |
| Blowdown | 30 | 400 | 159 |
| Receive Purge | 90 | 159 | 159 |
| Equalization | 55 | 159 | 1530 |

The feed gas composition is shown in Table 2:

TABLE 2

| | Mol-% |
|---|---|
| Methane | 14.1 |
| Ethane | 12.6 |
| Propane | 3.34 |
| n-Butane | 2.32 |
| n-Pentane | 0.755 |
| n-Hexane | 0.550 |
| Toluene | 0.051 |
| m-Xylene | 0.051 |
| Hydrogen | balance |

The experimental adsorber loading is shown in Table 3:

TABLE 3
Baseline Adsorber Loading

| | Vol-% |
|---|---|
| H-5 (Bottom) Alumina | 10 |
| H-3-1 (Middle) Silica Gel | 30 |
| H-2-12 (Top) Activated Carbon (coal-based) | 60 |

We measured the baseline performance with shorter cycle times (4.5-min and 3-min) at various product purities. Results are summarized in Table 4. From the data, we see that performance drops significantly with faster cycles. For example, at 900 ppmv methane in the product the hydrogen recovery decreases by 2.3 percentage points and the bed size factor (inversely proportional to feed per cycle) increases by 18% in going from 6 minutes to 3 minutes. The data also show that this performance gap does not decrease significantly with higher C₁ breakthrough.

TABLE 4
Results for Various Product Purities: Effect of Cycle Time.

| | | | |
|---|---|---|---|
| Run No. | Product C₁, ppmv | Feed, scf/cycle | H2 Recovery, % |

6-min Cycle

| | | | |
|---|---|---|---|
| 9 | 380 | 2.039 | 85.45 |
| 10 | 910 | 2.136 | 86.48 |
| 11 | 2,460 | 2.196 | 87.49 |

4.5-min Cycle

| | | | |
|---|---|---|---|
| 13 | 790 | 1.996 | 85.34 |

3-min Cycle

| | | | |
|---|---|---|---|
| 14 | 550 | 1.786 | 83.58 |
| 15 | 920 | 1.810 | 84.14 |
| 16 | 1,700 | 1.850 | 85.20 |
| 17 | 3,680 | 1.946 | 86.05 |

After the baseline testing described above, we vacuumed out the top half of the H-2-12 (coal-based) carbon layer and loaded a coconut activated carbon adsorbent. Results of these fast-cycle tests are summarized in Table 5. Under the same test conditions, the coconut carbon gives a performance advantage of 0.5 percentage points in hydrogen recovery over the previously used activated carbon. This performance increase remains approximately constant over the range of cycle times from 3 to 6 minutes.

TABLE 5
Results for Coconut Carbon.
Bed Loading: 10% H-5, 30% H-3-1, 30% H-2-12, 30% Coconut Carbon

Normalized to
800 ppmv C₁ Product

| Run No. | Cycle Time, min | Feed, scf/cycle | H₂ Rec, % |
|---|---|---|---|
| 19 | 6.0 | 2.168 | 86.92 |
| 21 | 4.5 | 2.081 | 86.02 |
| 23 | 3.0 | 1.921 | 84.41 |

After the coconut carbon testing, the top portion of the carbon section was vacuumed out and the top 25% was loaded with calcium X zeolite 8×12 molecular sieve beads. This was a commercial product consisting of calcium-exchanged 2.3-ratio zeolite 13X. The fast cycle tests were then repeated. The purpose of these tests was to determine if these 8×12 beads could match or exceed the performance of the carbon adsorbents at reduced cycle times, due to faster mass-transfer, even though the methane equilibrium isotherm is slightly worse than the activated carbon adsorbents.

The results for the calcium X zeolite are summarized in Table 6, showing an improvement in hydrogen recovery. We also measured the pressure drop for calcium exchanged zeolite molecular sieve 8×12 beads vis-à-vis H-2-12 activated carbon using air at 40 psig (276 kPa-g) in a 2.4-inch (6.1 cm) ID column. The pressure drop of the calcium X adsorbent was approximately 5% lower than H-2-12. Therefore, the lifting velocity of calcium X exchanged molecular sieve 8×12 beads is approximately 15% higher than H-2-12 activated carbon (due also to the higher loaded density of the molecular sieve).

TABLE 6
Results for Calcium X Zeolite (8 × 12 Beads).
Bed Loading 10% H-5, 30% H-3-1, 35% H-2-12, 25% Calcium X Zeolite

| | | Normalized to | |
|---|---|---|---|
| | | 800 ppmv C₁ Product | |
| Run No. | Cycle Time, min | Feed, scf/cycle | H2 Recovery, % |
| 24 | 6.0 | 2.113 | 87.13 |
| 25 | 4.5 | 2.105 | 86.84 |
| 26 | 3.75 | 2.001 | 86.36 |
| 27 | 3.0 | 1.923 | 85.76 |

Based upon the results discussed above, the performance of the H-2-12 activated carbon baseline diminished significantly with faster cycles (˜2 percentage point loss in hydrogen recovery with 3-minute cycle), and the performance gap did not vary much over a wide range of product purities.

A commercially available coconut carbon in the top 30% of the bed gave an improvement of 0.5 percentage points in hydrogen recovery compared to the H-2-12 activated carbon baseline over a range of cycle times from 3 to 6 minutes.

Calcium X zeolite 8×12 molecular sieve beads in the top 25% of the bed performed better than the H-2-12 activated carbon baseline and the coconut carbon over the full range of cycle times. The performance advantage of calcium X zeolite increased with fast cycles, indicating better mass-transfer performance of the molecular sieve adsorbent.

At the target cycle time of 4.5-minutes, the calcium X zeolite adsorbent gave an increase of 0.5 percentage points in hydrogen recovery and a decrease of 2% in bed size factor compared to the H-2-12 activated carbon baseline at 6 minutes. Further improvements can be obtained by decreasing the silica/alumina ratio, by increasing the calcium exchange level, and/or by increasing the fraction of bed volume loaded with calcium X zeolite.

1. A process for removing methane from a gas stream comprising hydrogen, methane and other impurities, said process comprising passing said gas stream through an adsorbent bed comprising a calcium X zeolite.

2. The process of claim 1 wherein said adsorbent bed comprising a calcium X zeolite results in at least 20% more throughput (feed gas volume) compared to an activated carbon adsorbent.

3. The process of claim 1 wherein said adsorbent bed comprising a calcium X zeolite provides for recovery of from about 83 to 93 wt. % of hydrogen within said gas stream.

4. The process of claim 1 wherein said calcium X zeolite comprising calcium exchanged at a level from 60 to 90%.

5. The process of claim 1 wherein said calcium X zeolite has a particle size from about 1.5 mm to 2.5 mm.

6. The process of claim 1 wherein said gas stream comprises from about 60 to 95 mol % hydrogen.

7. The process of claim 1 wherein said calcium X zeolite has a silicon to aluminum ratio from about 1.0 to 1.3.

8. The process of claim 1 wherein said process removes other impurities selected from the group consisting of carbon monoxide, nitrogen and ethane.

9. The process of claim 1 wherein said process has a cycle time from about 20 to 40% faster than a process using an activated carbon adsorbent.
